(19) United States
(12) Patent Application Publication
(10) Pub. No.: US 2003/0030289 A1
(43) Pub. Date: Feb. 13, 2003

(54) Lock link mechanism

(76) Inventors: Sidney Fisher, Worcester (GB); Gurbinder Kalsi, West Midlands (GB); Paul Beckett, West Midlands (GB)

Correspondence Address: CARLSON, GASKEY & OLDS, P.C., 400 WEST MAPLE ROAD, SUITE 350, BIRMINGHAM, MI, 48009, US

(21) Appl. No.: 10/208,963

(22) Filed: Jul. 31, 2002

(30) Foreign Application Priority Data
Aug. 9, 2001 (GB) GB 0119415.8

(51) Int. Cl. E05B 3/00

(52) U.S. Cl. 292/336.3

(57) ABSTRACT

A lock link mechanism for use with an manual input means, the mechanism comprising a drive member arranged so as to be connectable to an actuating means, and a link member wherein the mechanism is so constructed and arranged as to enable, in use, the manual input means to move the mechanism to a first position corresponding a locked state of an associated latch, but to substantially prevent manual actuation of the input means causing the mechanism to move from the first position to a second position corresponding to an unlocked state.

### CROSS REFERENCE TO RELATED APPLICATIONS

This application claims priority from United Kingdom (GB) Patent Application No. 0119415.8 filed on Aug. 9, 2001.

### BACKGROUND OF THE INVENTION

The present invention relates to a lock link mechanism. More particularly, the present invention relates to a lock link mechanism for use in conjunction with sill buttons on vehicle doors.

### SUMMARY OF THE INVENTION

Vehicle door latches commonly comprise a linkage mechanism arranged to interconnect a lock lever of the latch to a sill button, which, as the name suggests, retracts through an aperture on a window sill portion of the vehicle door. In normal use, the sill button is pushed down to cause the latch to be put into a locked state, and then either a key is turned in an external door mounted barrel, a remote keyless entry device is actuated, an inside door release handle is pulled, or the sill button lifted in order to unlock the vehicle should a user thereof wish to enter or exit the vehicle passenger compartment.

One problem associated with sill button linkages is that even if the sill button is designed so as not to have a portion engageable by a user above the surface of the sill when in a locked position, it is often still possible for unauthorized entry to be gained to the vehicle by the insertion of a so called “slim jim” type device between the bottom of the door window glass and the upper portion of the vehicle door outer panel in order to engage and lift a portion of the linkage.

The present invention seeks to overcome, or at least mitigate the problems of the prior art.

One aspect of the present invention provides a lock link mechanism for use with a manual input means, the mechanism comprising a drive member arranged so as to be connectable to an actuating means, and a link member wherein the mechanism is so constructed and arranged as to enable, in use, the manual input means to move the mechanism to a first position corresponding a locked state of an associated latch, but to substantially prevent manual actuation of the input means causing the mechanism to move from the first position to a second position corresponding to an unlocked state.

Embodiments of the invention are now described, by way of example only, with reference to the accompanying drawings.

### BRIEF DESCRIPTION OF THE DRAWINGS

FIG. 1A is a schematic side view of a lock link mechanism according to a first embodiment of the present invention in an unlocked state.

FIG. 1B illustrates the mechanism of FIG. 1A in a locked state.

FIG. 2A is a schematic side view of a lock link mechanism according to a second embodiment of the present invention in a locked state.

FIGS. 2B to 2D illustrate the linkage of FIG. 2A during successive stages of power unlocking.

FIG. 3 is an enlarged view of a portion of FIG. 2B designated “detail X”.

FIGS. 4A and 4B illustrate the mechanism of the second embodiment of the present invention when an attempt is made to manually displace the mechanism.

FIG. 5 is an enlarged view of a portion of the mechanism shown in FIG. 4B.

FIG. 6A is a schematic side view of a mechanism according to a third embodiment of the present invention in a locked state.

FIGS. 6B and 6C illustrate the mechanism of FIG. 6A in successive stages of unlocking.

### DETAILED DESCRIPTION OF THE PREFERRED EMBODIMENTS

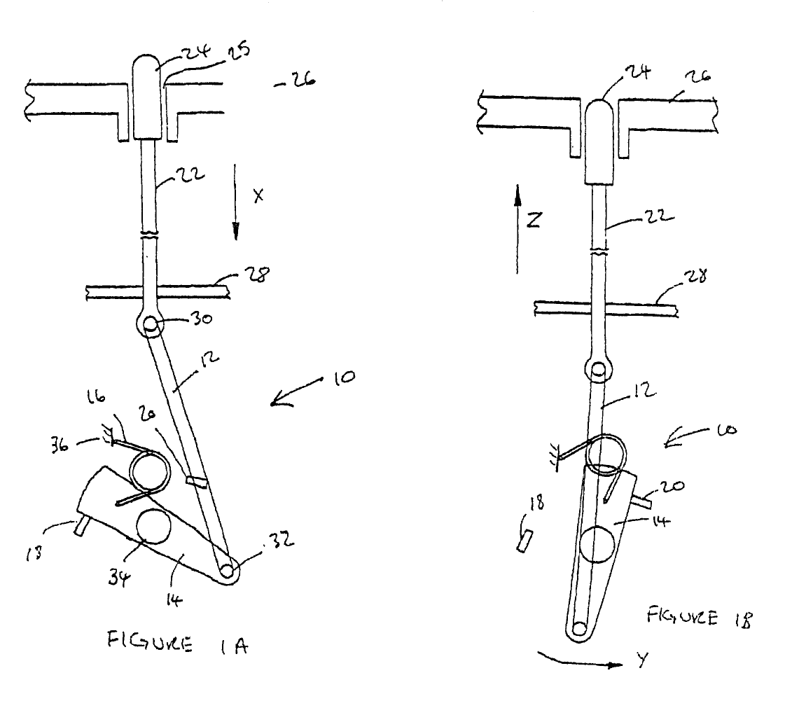

Referring to FIG. 1A, a schematic side view of a lock link mechanism 10 is shown. The mechanism comprises a drive member 14 secured at its middle portion onto a shaft 34. The shaft is rotatably mounted on a fixed member such as a latch chassis (not shown). The shaft preferably also acts as driven shaft for an actuating means such as a motor (not shown) and also provides an output from the mechanism to an associated latch to provide for locking and unlocking (see below). The drive member 14 is further pivotally connected at a first end to a link member 12 by a pin 32.

The extent of rotation of the drive member 14 is limited by an unlock stop 18 and a lock stop 20, both of which are also preferably secured to the chassis. One leg of a biasing member, such as a helical torsion spring 16, is pivotally mounted to the drive member 14, intermediate shaft 34, and a second end of the member 14, with the other leg being pivotally secured to a mounting point 36 on the chassis. The spring 16 is arranged to cause the drive member 14 to be in a stable rest position only when abutting either unlock stop 18 or lock stop 20, (i.e., the spring acts as an overcenter spring).

Link member 12 is further pivotally connected at a second end to a connecting rod 22 by a further pin 30. Pins 30 and 32 lie at opposite ends of the link member 12. The connecting rod 22 extends through a housing 28 of the mechanism and terminates at a sill button 24 arranged to protrude through an aperture 25 provided in the window sill 26 of a vehicle door. Housing 28 preferably acts both as a guide for rod 22 and as a shield to prevent tampering with the mechanism 10. In other embodiments, housing 28 may act as a stop in place of unlock stop 18. The mechanism is shown in FIG. 1A in a state corresponding to an associated latch mechanism (not shown) being unlocked (hereinafter referred to as an unlocked state).

Referring to FIG. 1B, the mechanism 10 is shown in a state corresponding to the associated latch mechanism being locked (hereinafter referred to as a locked state). This state is achieved by a vehicle user pressing downwardly in a direction X on sill button 24 against the resilience of spring 16, causing the drive member 14 to rotate and engage lock stop 20. In this state, the drive member 14 is rotated slightly past vertical, thereby causing an over-center effect by virtue of the biasing effect of spring 16. In particular, the rotational axis of shaft 34 sits to the right of a line connecting pins 30 and 32. Locking may also be achieved by the drive member 14 being caused to rotate clockwise by the motor.

It is therefore clear from FIG. 1B that it is not possible for the sill button 24 to be lifted manually when in a locked state because the button itself is below the surface of the window sill 26. Furthermore, engagement of connecting rod 22 by a slim jim type device would be unable to cause unlocking due to the over-centre effect described above.

Rather, unlocking of the link member 12 may only be effected by the motor, causing the drive member 14 to be rotated back to the position shown in FIG. 1A in a direction Y and also causing the sill button 24 to be redeployed in a direction Z.

It should be appreciated that the motor may be driven under the influence of alternative input means such as switches (not shown) mounted elsewhere in the vehicle or passenger area or the inside door release handle (not shown) for example. If the alternative input means is the inside door release handle, the mechanism may provide an override unlocking function.

Override unlocking is a function whereby operation of an inside door handle with the latch in a locked condition causes unlocking of the latch. Note that override unlocking is applicable to a latch in a locked “child safety off” condition, and is also applicable to a latch in a locked “child safety on” condition. In particular, starting from a “locked child safety on” condition of a latch having override locking, an actuation of the inside handle will unlock the door, but this operation or any subsequent operation of the inside door handle will not unlatch the door since the child safety feature is on. Nevertheless, once the latch has been unlocked by actuation of the inside door handle, a subsequent operation of the outside door handle will unlatch the latch. In particular, it should be noted that this situation is different from a superlocked latch since in this case a particular sequence of handle operations, i.e. operation of the inside handle followed by operation of the outside handle, will open the door. This is not the case for superlocking.

In certain classes of embodiment, the motor is replaced by alternative actuating means, such as a mechanical linkage operably connected to the inside door release handle, for example.

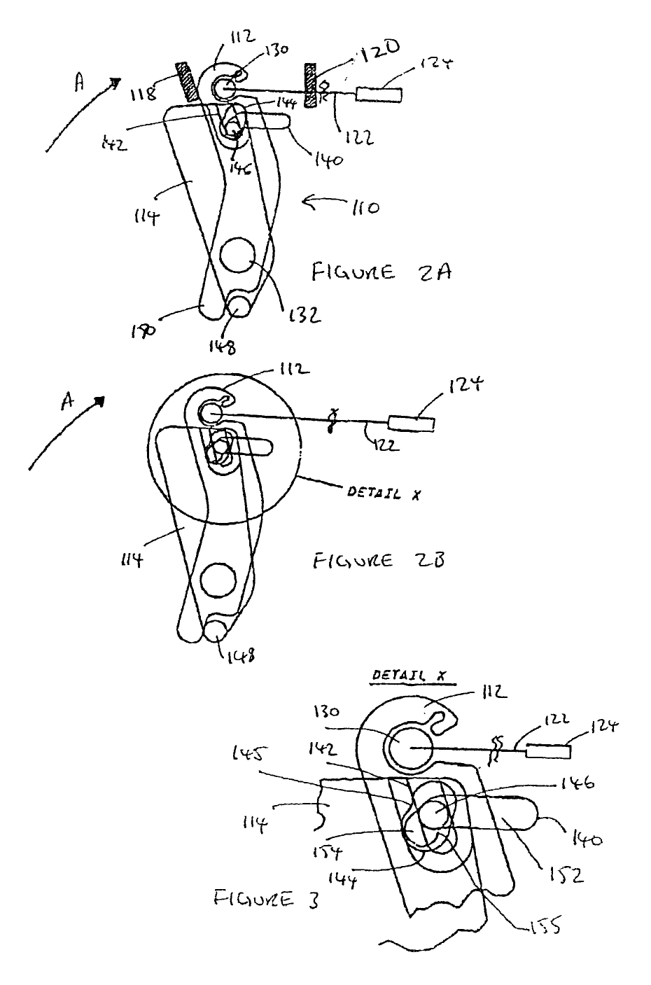

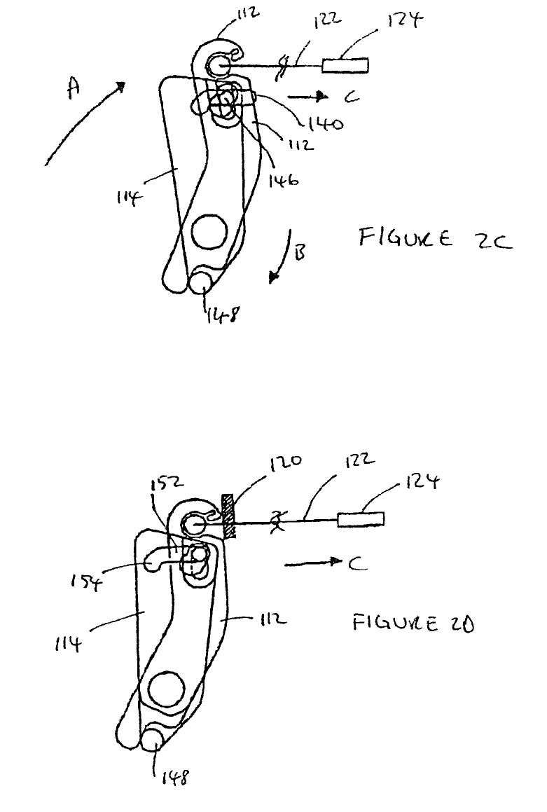

Turning now to the second embodiment of the invention illustrated in FIGS. 2A to 5, and referring in particular to FIG. 2A, it can be seen that the mechanism comprises a link member 112 and drive member 114 that are mutually pivotable near first ends thereof in relation to a fixed chassis (not shown). Drive member 114 is mounted rotationally fast to a shaft 132 and link member 112 is freely pivotable about the shaft 132. As in the first embodiment, shaft 132 is both a driven shaft for a motor and an output shaft to an associated latch mechanism. A projection 148 is provided on the drive member so as to cooperate with a nose portion 150 of the link member 112 and cause both of the members to rotate simultaneously when the drive member 114 rotates.

A linkage rod 122 is pivotally mounted proximate a second end of the linkage member 112 by a pin 130. The other end of rod 122 has a sill button 124 mounted thereon in a similar manner to the sill button 24 of the first embodiment. As in the first embodiment, unlock and lock stops 118 and 120 are provided to limit the rotation of the mechanism 110 and the link member is biased by resilient means (not shown) so as to be stable only when abutting one of the stops 118, 120.

An elongate slot 140 having a cranked portion 154 and a straight portion 152 is provided in the chassis of the mechanism and has independently slideable pin 146 provided therein. Additionally, a slot 144 whose longitudinal axis is at an inclined small angle clockwise from the horizontal when fitted in situ in a vehicle door is provided in the link member 112. A further elongate slot 142 is provided inclined at a small angle anti-clockwise from the horizontal in situ on drive member 114. The pin 146 is additionally slideable in these slots. It can be seen from FIG. 2A that when the mechanism is in the locked position, the pin 146 rests in the lower portions of the slots 142 and 144 as well as the bottom of the cranked portion 154 of slot 140.

In order to unlock the mechanism 110, the motor drives the drive member 114 in a clockwise direction indicated by arrow A. In turn this simultaneously causes the link member 112 to also be driven in a clockwise direction indicated by arrow B by virtue of the projection 148 and nose 150 arrangement. The simultaneous driving of the two members 114 and 112 enables the pin 146 to move up the cranked portion 154 of slot 140 while being able to freely move within slots 144 and 142. This is illustrated in FIGS. 2B and 3.

Once the pin 146 reaches the straight portion 152 of slot 140, both the drive member 114 and link member 112 may continue to rotate until stop 120 is engaged or the pin 146 abuts the end of the slot 140. This is illustrated by FIGS. 2C and 2D. Once the mechanism reaches the position shown in FIG. 2D, the associated latch is caused to be unlocked due to rotation of shaft 132. Rotation of link member also causes sill button 124 to redeploy in a direction indicated by arrow C.

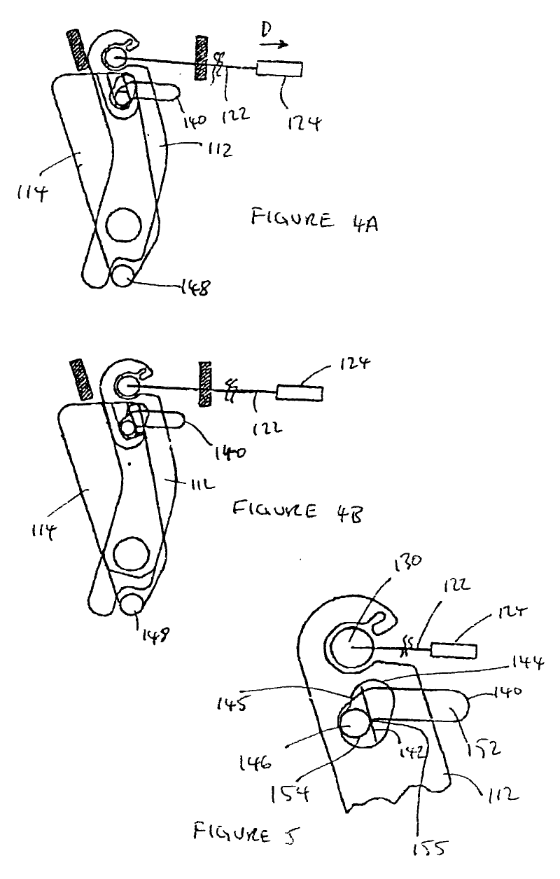

Referring now to FIGS. 4A, 4B and 5, the functioning of the mechanism is illustrated when an unauthorized user attempts to cause rotation of the mechanism by pulling on the sill button 124 in the direction as indicated by arrow D, or by using a “slim jim” device as described above.

From FIG. 4B, it can be seen that it is possible for the button to be displaced slightly in a clockwise direction and the link member 112 to be lifted slightly from lock stop 120. However, the arrangement of projection 148 and nose 150 means that no displacement of the drive member 114 occurs and, as can be seen most clearly from FIG. 5, the slight rotation of link member 112 coupled to the lack of rotation of the drive member causes pin 146 to abut the edges of slots 142 and 144 and the edge of cranked portion 154 of slot 140, jamming the pin 146 in the slots 140, 142, 144. In other words, the shape of the slots 140, 142 and 144 combined with the pin's 146 natural movement create a blocking structure that blocks manual rotation of the link member. As such, pin 146 is prevented from sliding up the cranked portion 154 and the mechanism 110 is thus prevented from rotating any further from the position shown in 4B. This means that no unlocking of the associated latch mechanism may occur.

Curved portions 145 and 155 of slots 144 and 140 are arranged so as to ensure that the pin 146 is securely held in place.

In this embodiment, the rest position of the pin 146 in the cranked portion of the slot is determined by its own weight when fitted in its usual orientation within a vehicle door. However, in alternative embodiments the pin 146 may be urged into this position by a light bias spring to enable the mechanism to operate in any orientation.

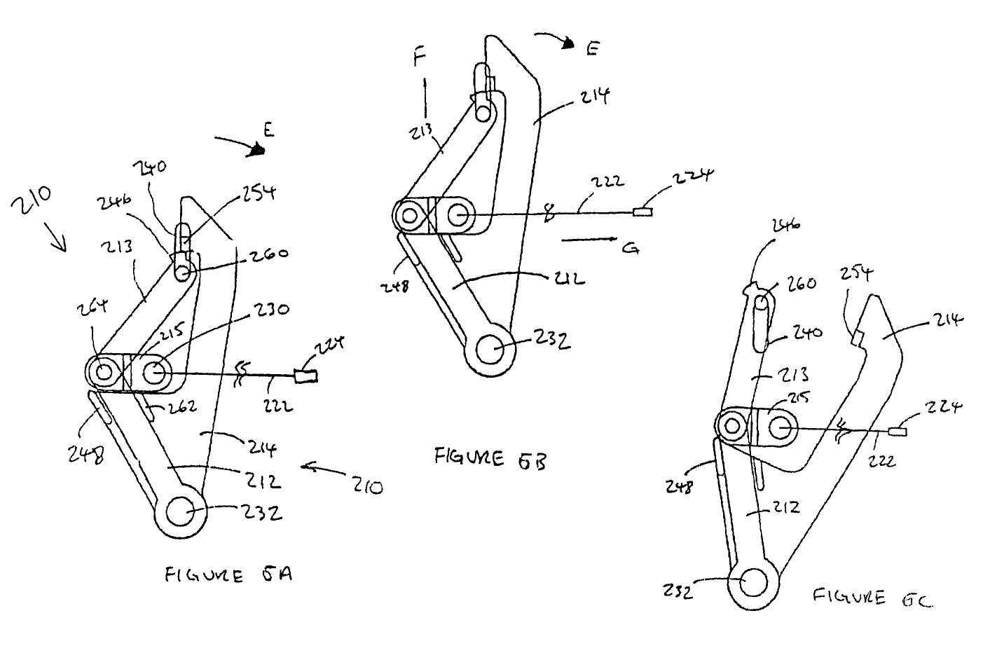

Turning now to the third embodiment of the present invention illustrated in FIGS. 6A to 6C, the mechanism 210 of FIG. 6A comprises a drive member 214 and a link member 212 mounted to a chassis (not shown) of the mechanism at proximate first ends thereof by a shaft 232. The shaft 232 preferably performs the function of a driven shaft to drive member 214 and of an output shaft from the mechanism to an associated latch as in the first two embodiments. An abutment member 213 is further pivotally connected to the link member 212 at a second end of the link member 212 by a further pin 264. A second end of the abutment member 213 has provided thereon a pin 260 slideably mounted within a slot 240 provided on the chassis. An abutment surface 246 is further provided near pin 260 and is arranged to abut a stop 254 provided at a second end of the drive member 214. In this embodiment, a further link member 215 is pivotally mounted to pin 264 at one end and to a connecting rod 222 by a further pin 230 at a second end. As in the previous embodiments, the connecting rod terminates in a sill button 224.

Two further projections 248 and 262 are mounted on the drive member 214 on either side of the link member 212 to permit a limited amount of relative rotation between the link and drive members 212 and 214.

In use, a drive motor (not shown) causes the drive member 214 to rotate in a clockwise direction as indicated by arrow E. This rotation causes link member 212 to also rotate by virtue of projection 248 (once a predetermined amount of free play has been taken up). The play between the drive member 214 and the link member 212 enables stop 254 to pivot out of contact with surface 246 as shown in FIG. 6B, enabling engagement member 213 to slide along slot 240 and thereby permitting the continued rotation of link member 212 and drive member 214. In turn, this causes the shaft 232 to rotate, unlocking the associated latch. Additionally, the movement of link 213 in direction F causes the sill button to be displaced in direction G so that it may again protrude above the level of the window sill (not shown).

The mechanism in a fully unlocked condition is shown in FIG. 6C. Locking of the device may be achieved by either pressing downwardly on sill button 224 or by reversing the motor drive.

If an attempt is made to manually actuate the sill button, this will cause the link member 212 to pivot without corresponding pivoting of the drive member 214 as far as stop 262. In turn, this causes surface 246 to abut stop 254, preventing pin 260 from sliding up slot 240, meaning that unlocking cannot occur.

Numerous changes may be made within the scope of the present invention. For example, the mechanisms may be adapted for use in alternative devices where manual actuation is required in one direction, but is to be prevented in an opposite direction.

It should be understood that various alternatives to the embodiments of the invention described herein may be employed in practicing the invention. It is intended that the following claims define the scope of the invention and that the method and apparatus within the scope of these claims and their equivalents be covered thereby.

We claim:

1. A lock link mechanism, comprising:
a drive member; and
a link member coupled to the drive member,
wherein the link member and the drive member are manually rotatable to a first position corresponding to a locked state of an associated latch and are prevented from being manually rotatable from the first position to a second position corresponding to an unlocked state.

2. The lock link mechanism according to claim 1, further comprising manual input means, wherein the manual input means moves the drive member and the link member to the first position.

3. The lock link mechanism according to claim 2, wherein the manual input means is a sill button.

4. The lock link mechanism according to claim 1, wherein the drive member and link member are pivotally connected.

5. The lock link mechanism according to claim 1, further comprising an actuator connected to the drive member.

6. The lock link mechanism according to claim 5, wherein the actuator is a power actuator.

7. The lock link mechanism according to claim 6, wherein the link member is movable from the first position to the second position only by the power actuator connected to the drive member.

8. The lock link mechanism according to claim 5, wherein the actuator is an inside door release handle.

9. The lock link mechanism according to claim 8, wherein the lock link mechanism has an override unlocking function.

10. The lock link mechanism according to claim 1, further comprising a biasing member that biases the drive member in the first and second positions to have an overcenter effect.

11. The lock link mechanism according to claim 10, wherein the biasing member is a resilient member.

12. The lock link mechanism according to claim 11, wherein the resilient member is mounted between the drive member and a fixed location.

13. The lock link mechanism according to claim 1, further comprising a blocking structure that prevents manual rotation of the drive member and the link member from the first position to the second position.

14. The lock link mechanism according to claim 13 wherein the blocking structure comprises a pin and slot arrangement.

15. The lock link mechanism according to claim 14, wherein the pin and slot arrangement comprise a first slot disposed in the drive member, a second slot disposed in the link member, a third slot disposed in a latch chassis, and a pin extending through the first, second and third slots.

16. The lock link mechanism according to claim 14, wherein the pin and slot arrangement jams when the link member is manually actuated from the first position to the second position allows the link member to move from the first position to the second position when the link member is actuated via the drive member.

17. The lock link mechanism according to claim 14, wherein the pin and slot arrangement comprises at least one non-linear slot.

18. The lock link mechanism according to claim 13, wherein the blocking structure comprises:
an abutment member having an abutment surface; and
a stop disposed on the drive member, wherein the stop is selectively contacted by the abutment member.

19. The lock link mechanism according to claim 18, wherein the abutment surface abuts the stop when the link member is manually actuated and wherein the abutment surface misses the stop when the link member is actuated via the drive member.

20. The lock link mechanism according to claim 18, wherein the abutment member is pivotally connected to the link member.

21. The lock link mechanism according to claim 20, wherein the abutment member is further provided with a pin pivotally slidable within a slot formed in a latch chassis.

22. A latch for a vehicle door, comprising:
a latch chassis;
a shaft rotatably mounted on the latch chassis;
a drive member coupled to the shaft;
a manual input means; and
a link member pivotally coupled to the drive member, wherein the link member and the drive member are manually rotatable via the manual input means to a first position corresponding to a locked state of an associated latch and are prevented from being manually rotatable from the first position to a second position corresponding to an unlocked state.

23. The latch according to claim 22, wherein the drive member and link member are pivotally connected.

24. The latch according to claim 22, further comprising an actuator connected to the drive member, wherein the link member is movable from the first position to the second position only by the actuator connected to the drive member.

25. The latch according to claim 22, further comprising a biasing member that biases the drive member biases the drive member in the first and second positions to have an overcenter effect.

26. The latch according to claim 22, further comprising a blocking structure that prevents manual rotation of the drive member and the link member from the first position to the second position.

27. The latch according to claim 26, wherein the blocking structure is a pin and slot arrangement having a first slot disposed in the drive member, a second slot disposed in the link member, a third slot disposed in the latch chassis, and a pin extending through the first, second and third slots.

28. The latch according to claim 27, wherein the pin and slot arrangement jams when the link member is manually actuated from the first position to the second position and allows the link member to move from the first position to the second position when the link member is actuated via the drive member.

29. The latch according to claim 27, wherein the pin and slot arrangement comprises at least one non-linear slot in the latch chassis.

30. The latch according to claim 26, wherein the blocking structure comprises:
an abutment member having an abutment surface; and
a stop disposed on the drive member, wherein the stop is selectively contacted by the abutment member.

31. The latch according to claim 30, wherein the abutment surface abuts the stop when the link member is manually actuated and wherein the abutment surface misses the stop when the link member is actuated via the drive member.

32. The latch according to claim 30, wherein the abutment member is pivotally connected to the link member.

33. The latch according to claim 32, wherein the abutment member is further provided with a pin pivotally slidable within a slot formed in a latch chassis.
